(19) United States
(12) Patent Application Publication
(10) Pub. No.: US 2011/0142533 A1
(43) Pub. Date: Jun. 16, 2011

(54) JOINT ASSEMBLY FOR BABY STROLLER

(75) Inventors: Shi Quan Liu, Guang Dong (CN); Kuang-Neng Cheng, Chiayi County (TW)

(73) Assignee: Lerado (Zhong Shan) Industrial Co., Ltd., Guang Dong Province (CN)

(21) Appl. No.: 12/968,916

(22) Filed: Dec. 15, 2010

(30) Foreign Application Priority Data
Dec. 16, 2009 (CN) 200920274570.4

(51) Int. Cl. F16C 11/04

(52) U.S. Cl. 403/119

(57) ABSTRACT

A joint assembly for baby stroller includes at least a first joint half and a second joint half, the first joint half pivotably connected with the second joint half. The first joint half is featuring with connecting a lower bar through a bended section or a bended connector, and the second joint half is featuring with connecting an upper bar through another bended section or bended connector bending in opposite direction, so as to limited the upper bar and the lower bar to rotate in different planes and spaced apart from each other thereby to prevent user's finger pinched by the gap between the upper bar and the lower bar.

### CROSS-REFERENCE TO RELATED APPLICATIONS

This non-provisional application claims priority under 35 U.S.C. §119(a) on Patent Application No(s). 200920274570.4 filed in People's Republic of China on Dec. 16, 2009, the entire contents of which are hereby incorporated by reference.

### BACKGROUND OF THE INVENTION

The present invention relates generally to a joint assembly for baby stroller that can prevent the bars pivoted by the joint assembly from pinching user's finger.

### DESCRIPTION OF THE RELATED ART

Strollers are widely used to transport infants. A stroller consists of a frame, a seat, four wheel assemblies, and a handle. The front two wheel assemblies typically rotate to enable the stroller to easily change direction and the rear two wheel assemblies are typically fixed to provide straight line stability. The most popular type of stroller contains a tubular frame with a scissor mechanism that enables the stroller to fold (or collapse) when not in use. This type of stroller is commonly known as an umbrella stroller because of the way it folds. Umbrella strollers are sold by many different companies.

A conventional umbrella stroller 10 in erected position is shown in FIG. 1. The frame of the stroller 10 includes a front strut 11, a rear strut 12, a handle bar 13 on each side. A joint 16 connects between the front strut 11 and the handle bar 13. The frame includes a seat support bar 14 for support a seat. The frame also includes a pair of cross-link bars 15 that extends between connectors near the bottom of the front strut 11 and near the bottom of the rear strut 12. The frame further includes a pair of cross-link bars 15 that extends between the handle bar 13. The cross-link bars 15 provide strength to the frame. They also lock the stroller in the erected position and prevent accidental folding when an infant is in the stroller 10. When the umbrella stroller 10 is folded, the two pair of cross-link bars 15 are unlocked, the two sides collapse toward each other, and the handle bars 13 pivot forward onto the front struts 11.

However, when a user is pivoting the handle bars 13 forward onto the front struts 11, the fingers are easily to be caught and pinched by the gap between the handle bars 13 and the front struts 11.

### SUMMARY OF THE INVENTION

To solve the finger-pinch problem, the present invention provides a joint assembly for baby stroller that includes at least a first joint half and a second joint half, the first joint half is pivotably connected with the second joint half. The first joint half is featuring with connecting a lower bar through a bended section, or a bended connector, and the second joint half is also featuring with connecting an upper bar through another bended section or bended connector bending in opposite direction, so as to limited the upper bar and the lower bar to rotate in different planes and spaced apart from each other thereby to prevent user's finger pinched by the gap between the upper bar and the lower bar.

### BRIEF DESCRIPTION OF THE DRAWINGS

The accompanying drawings, which are included to provide a further understanding of the invention are incorporated in and constitute a part of this specification, illustrate embodiments of the invention and together with the description serve to explain the principles of the invention. In the drawings:

FIG. 1 is a perspective view illustrating the basic structure of a traditional umbrella stroller (prior art).

FIG. 2 is a perspective view showing an embodiment of the joint assembly according to the present invention being installed on a collapsible stroller frame.

FIG. 3 is a rear elevation view showing the embodiment of the joint assembly according to the present invention being installed on a collapsible stroller frame.

FIG. 4 is an exploded perspective view showing the embodiment of the joint assembly according to the present invention.

FIG. 5 is an elevation view illustrating the operation of the joint assembly according to the present invention.

FIG. 6 is a perspective view of the joint assembly according to the present invention.

FIG. 7 is an elevation view showing a joint assembly according to the present invention, which has two joint half formed with bended connector for connecting an upper bar and a lower bar.

FIG. 8 is an elevation view showing another joint assembly according to the present invention, which includes two joint half formed in P-like configuration.

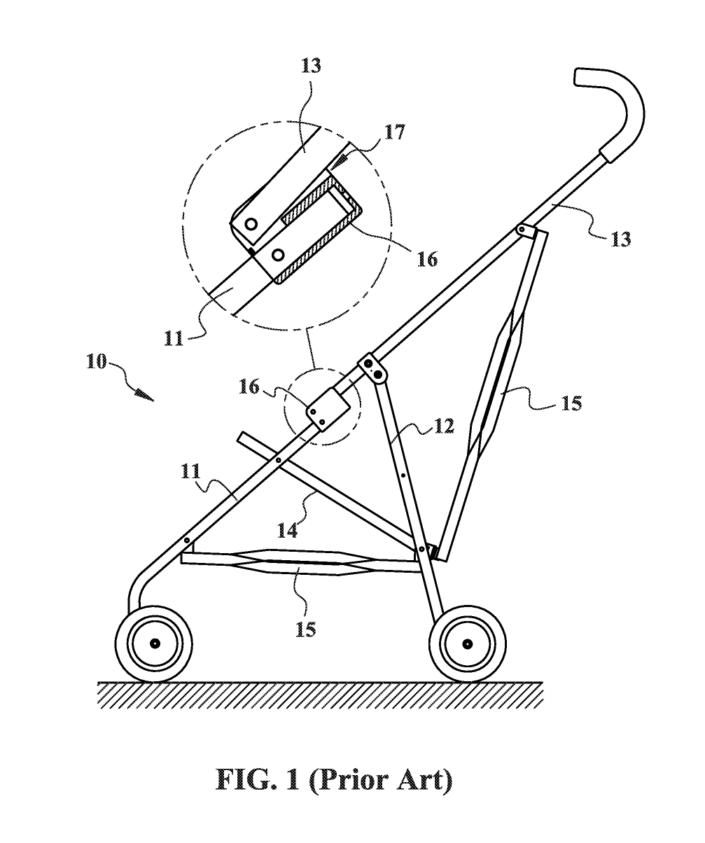

### DETAILED DESCRIPTION OF THE PREFERRED EMBODIMENTS

Reference will now be made in detail to the preferred embodiments of the present invention, examples of which are illustrated in the accompanying drawings.

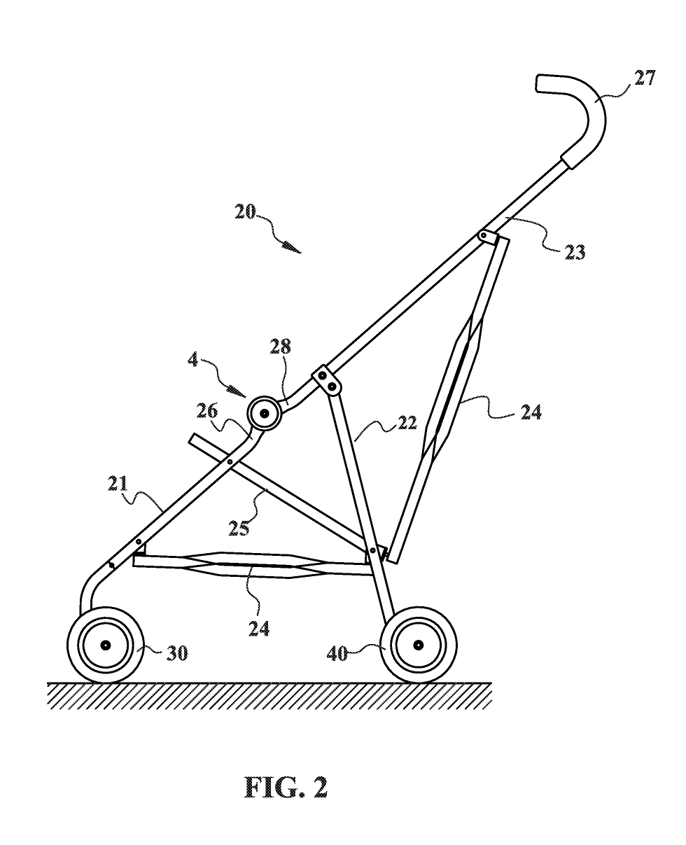

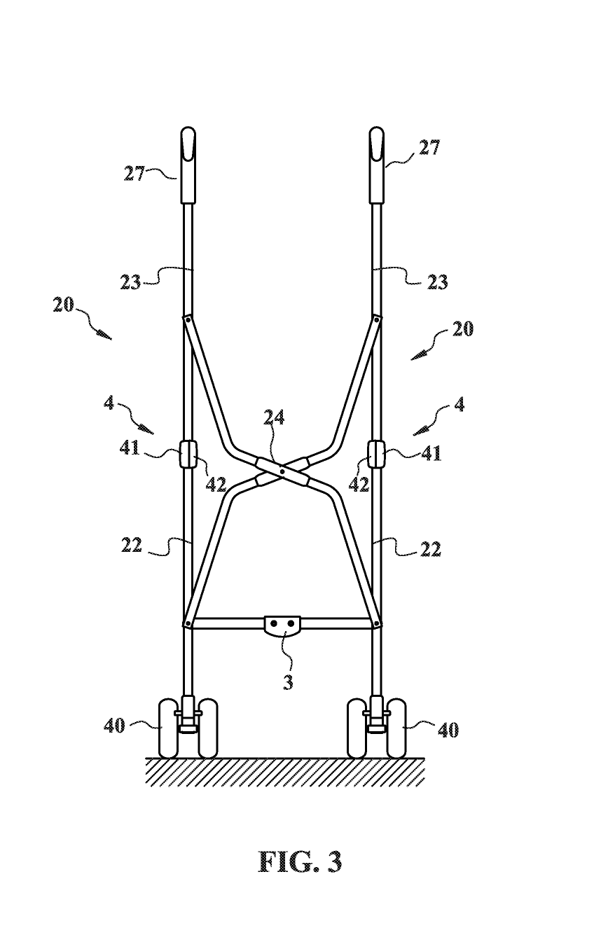

Referring to FIGS. 2 to 4, a joint assembly 4 mounted on a collapsible baby stroller frame 20 according to the present invention, includes an upper bar 23, a lower bar 21, a first joint half 41 and a second joint half 42. The collapsible baby stroller frame 20 may have a deployed position for use, and a folded position for stowing in a compact configuration.

The collapsible baby stroller frame 20 has a right side and a left side, each side further include a front wheels 30 connected to the lower end of the lower bar 21, a rear strut 22 pivoted to the upper bar 23 with the upper end thereof and a lower end connected with a rear wheels 40, a pair of cross-link bars 24 and a folding control assembly 3 operatively connected between the right side and left side for carrying the both sides in a transversal folding and erecting, and a seat support bar 25 for supporting a seat thereon.

The upper bar 23 may be embodied as a handle bar of the collapsible baby stroller frame 20, which includes a grip 27 mounted on top of its upper end and a second bended section 28 bending in a second bending direction at its lower end.

The lower bar 21 may be embodied as a front strut of the collapsible baby stroller frame 20, which includes a first bended section 26 bending in a second bending direction opposite to the second bending direction.

The first joint half 41 and second joint half 42 pivotally contact with each other by a first contacting side 43 and a second contacting side 48. The first joint half 41 connects with the first bended section 26 of the lower bar 21, the second joint half 42 pivots with the first joint half 41 and connects with the second bended section 28. In such a way, to let the first bending direction 26 and the second bending direction 28 bending opposite to each other, to permit the upper bar 23 and the lower bar 26 rotatable in two parallel plans and spaced apart from each other in a distance thereby to prevent user's finger pinched by the gap between the upper bar 23 and lower bar 26. Preferably, the upper bar 23 and the lower bar 21 are spaced apart from each other by a minimum distance of 5 mm.

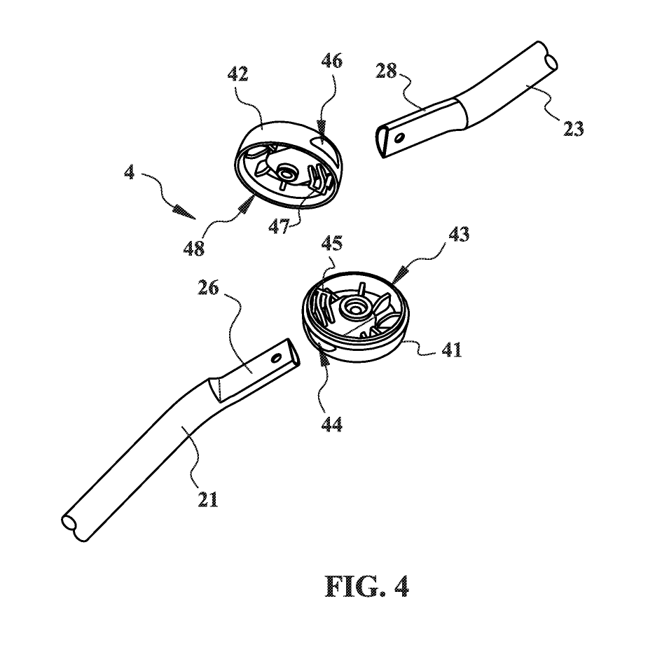

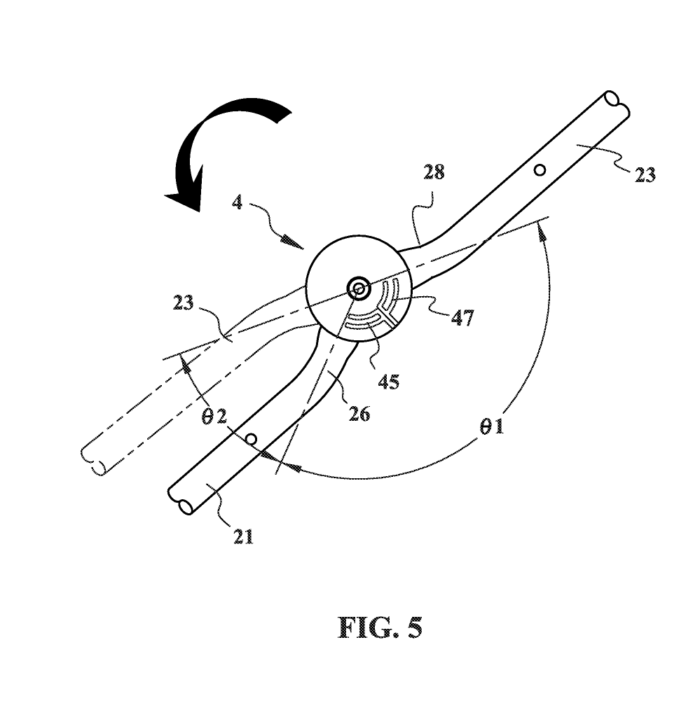

Preferably, the first joint half 41 and the second joint half 42 may be formed with a first stopper 45 and a second stopper 47 as shown in FIGS. 4 and 5, so as to provide an angle position to the joint assembly 4 during the stroller frame 20 is in a deployed position as shown in FIG. 2.

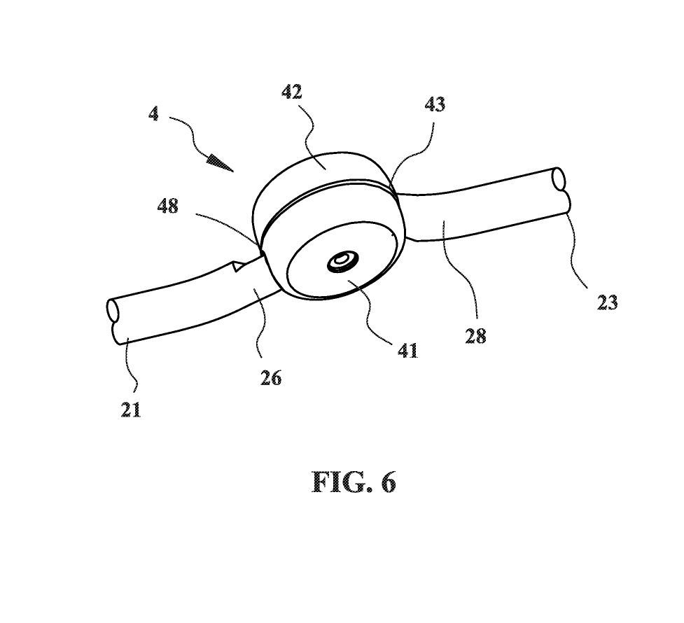

In the embodiment of FIGS. 4 to 6, a socket is formed within the first joint half 41 for using as a first connecting portion 44 for connecting with the lower bar 21, and similarly another socket is formed within the second joint half 42 for using as a second connecting portion 46 for connecting with the upper bar 23.

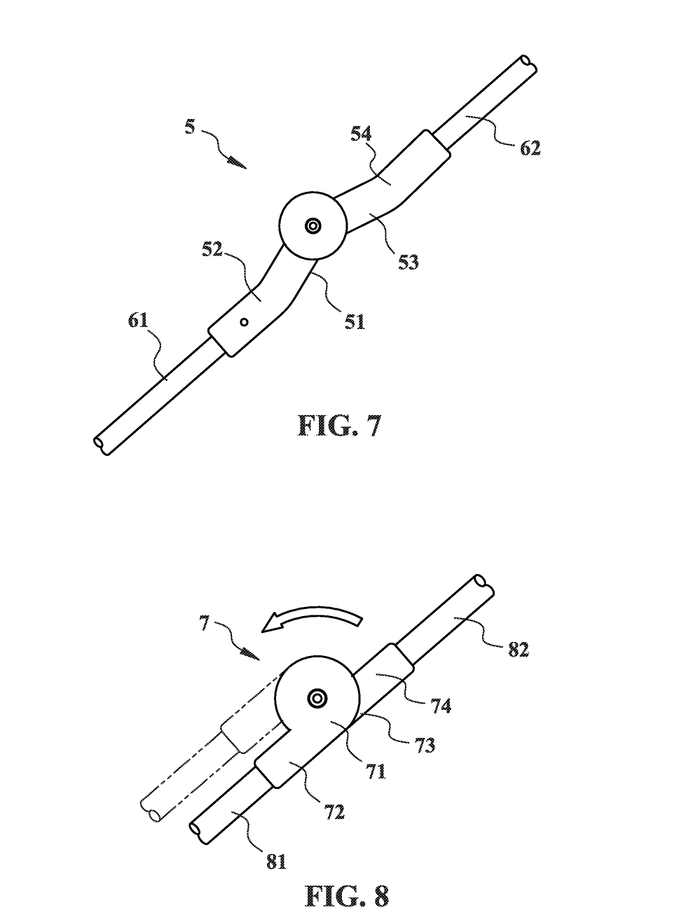

Nevertheless, the first connecting portion 44 and the second connecting portion 46 are not limited to be embodied as the sockets, it can be a length of an extension or protruded portion formed integrally with the first joint half 41 and the second joint half 42. For instance, the embodiment of joint assembly 5 as showed in FIG. 7, includes a first joint half 51, a second joint half 53.

In the present embodiment, a first bended section 52 extends outwardly from a first joint half 51 in a first direction for connecting with a lower bar 61, a second bended section 54 extended outwardly from a second joint half 53 in a second direction for connecting with a upper bar 62; wherein the first bending direction and the second bending direction are opposite to each other, and cause the upper bar 62 and the lower bar 61 limited to be rotatable in parallel plans and spaced apart from each other.

The first joint half 51 and the second joint half 53 may also be formed with a first stopper and a second stopper (both are not shown in FIG. 7) similar to the same shown in FIGS. 4 and 5 for providing an angle position of the joint assembly 5 during the stroller frame 20 is in a deployed position.

Referring to FIG. 8, the first joint half 71 and the second joint half 73 of a joint assembly 7, both can be embodied as a P-like configuration. The first joint half 71 includes a first disk-like body and a first connecting portion 72 with a direction deviating the axis of said first disk-like body for connecting with a lower bar 81.

Similarly, the second joint half 73 also includes a second disk-like body pivoted with the first joint half 71 and a second connecting portion 74 with a direction deviating an axis of the second disk-like body thereof for connecting with a upper bar 82. By this way, the upper bar 82 and the lower bar 81 are parallel and spaced apart from each other, when the baby stroller frame 20 is in a folded position.

It would be appreciated that the first connecting portion 72 can be integrally extended from the first disk-like body, and the second connecting portion 73 is integrally extended from the second disk-like body thereof.

While particular embodiments of the invention have been described, those skilled in the art will recognize that many modifications are possible that will achieve the same goals by substantially the same system, device or method, and where those systems, devices or methods still fall within the true spirit and scope of the invention disclosed.

What is claimed is:

1. A joint assembly for baby stroller, including:
an upper bar, having a second bended section with a second bending direction;
a lower bar, having a first bended section with a first bending direction;
a first joint half connected with the first bended section; and
a second joint half pivoted with the first joint half and connected with the second bended section;
wherein the first bending direction and the second bending direction are opposite to each other, and cause the upper bar and the lower bar to be rotatable in parallel plans and spaced apart from each other.

2. The joint assembly for baby stroller of claim 1, wherein the JOINT ASSEMBLY is installed on a stroller with a cross-link bars operatively connected between the right and lift sides thereof, thereby to help the folding of the stroller in a transverse direction.

3. The joint assembly for baby stroller of claim 1, wherein the first joint half and the second joint half are formed with a first stopper and a second stopper for providing an angle position of the joint during the stroller is in a deployed position.

4. The joint assembly for baby stroller of claim 1, the first joint half has a first connecting portion for connecting with the lower bar, and the second joint half has a second connecting portion for connecting with the upper bar.

5. The joint assembly for baby stroller of claim 4, wherein the first connecting portion is formed within the first joint half, and the second connecting portion is formed within the second joint half.

6. The joint assembly for baby stroller of claim 4, wherein the first connecting portion has a length protruded from the first joint half, and the second connecting portion has a length protruded from the second joint half.

7. The joint assembly for baby stroller of claim 1, wherein the upper bar and the lower bar are rotatable in different plans spaced apart from each other by a minimum distance of 5 mm.

8. A joint assembly for baby stroller, including:
a first joint half, having a first bended section extended outwardly in a first direction for connecting with a lower bar; and
a second joint half having a second bended section extended outwardly in a second direction for connecting with a upper bar; wherein the first bending direction and the second bending direction are opposite to each other, and cause the upper bar and the lower bar to be rotatable in parallel plans and spaced apart from each other.

9. The joint assembly for baby stroller of claim 8, wherein the first joint half and the second joint half are formed with a first stopper and a second stopper for providing an angle position of the joint assembly during the stroller is in a deployed position.

10. A joint assembly for baby stroller, including:
a first joint half, having first disk-like body and a first connecting portion with a direction deviating an axis of said first disk-like body for connecting with a lower bar; and
a second joint half, having second disk-like body pivoted with the first joint half and a second connecting portion with a direction deviating an axis of said second disk-like body for connecting with a upper bar;
wherein the upper bar and the lower bar are parallel and spaced apart from each other, when the baby stroller is in a folded position.

11. The joint assembly for baby stroller of claim 10, wherein the first connecting portion is integrally extended from the first disk-like body, and the second connecting portion is integrally extended from the second disk-like body.

12. The joint assembly for baby stroller of claim 10, wherein the first joint half and the first connecting portion are formed integrally as a P-like configuration, and the second joint half and the second connecting portion are formed integrally as a P-like configuration.
